(19) United States
(12) Patent Application Publication
(10) Pub. No.: US 2020/0391362 A1
(43) Pub. Date: Dec. 17, 2020

(54) Mobile Phone Display Membrane Separating Tool and Method

(71) Applicant: Jun Hyuk Park, Mississauga (CA)

(72) Inventor: Jun Hyuk Park, Mississauga (CA)

(21) Appl. No.: 16/946,016

(22) Filed: Jun. 2, 2020

Related U.S. Application Data
(60) Provisional application No. 62/856,995, filed on Jun. 4, 2019.

(51) Int. Cl. B25B 27/14; B32B 43/00

(52) U.S. Cl. CPC B25B 27/14; B32B 2457/20; B32B 43/006

(57) ABSTRACT

A tool, which is thin yet strong enough to be pushed through the adhesive layer on a mobile phone display. Its function is to separate the membranes of mobile phone displays for repair purposes. The tool is highly flexible to accommodate the separation of curved glass membranes.

### FIELD OF THE INVENTION

The following invention relates to a tool and method used to separate the membranes present on mobile phone displays.

### DESCRIPTION OF THE RELATED ART

The digital visual display of most modern mobile phone devices is comprised of three distinct membranes: one on the exterior, most often made of glass or another material that offers transparency for the display to be visible, one below the outer most layer which facilitates touch screen capacity, known as the digitizer, and one underneath the digitizer that displays images commonly called LCD or LED. Mobile phone devices are prone to damage due to frequent handling and falls that occur as a result. When a mobile phone display is damaged, the damage often occurs in a manner that only affects the outer membrane of the display, (commonly called the front glass), resulting in an aesthetically broken but still functional display.

Certain tools and methods have been developed specifically to remove the shattered outer glass membrane on broken mobile phone displays. The main examples include the following method(s):

Heating or freezing the shattered outer glass membrane to loosen the adhesive binding it to the device so it can be removed. The removal is done either by using a specialty wire tool or a playing card/business card to separate the outer glass membrane from the device.

However, there are several disadvantages to using the abovementioned methods & tools, including the following:

a) In order to use the freezing method, specialty equipment is required. This adds costs and further inconveniences to the process.
b) When the wire tool method is used, the wire often breaks during the process. The wire tool also requires both hands to operate and can only be used in a pulling motion, which limits its application.
d) When a business card or playing card is used, the material is often too thick and too soft to remove the glass in an efficient manner, adding time to the repair and increasing the chances of damage to the LCD and digitizer layers.

Considering the disadvantages to each repair method outlined above, it is apparent that a need exists in the mobile phone repair industry for better tools and methods of separating the glass membranes present on mobile phone devices.

### BRIEF SUMMARY OF THE INVENTION

The following invention seeks to provide a solution to this problem by serving as a tool that allows for an easier method of separating the damaged outer membrane from the otherwise functional mobile phone device.

### BRIEF DESCRIPTION OF THE DRAWINGS

FIG. 1. is a view of the bottom or the top side of the tool.

FIG. 2. Is a variation of the tool that can be used for smaller devices.

FIG. 3. Is a variation of the tool as seen in FIG. 1

FIG. 4. Is a variation of the tool as seen in FIG. 2

FIG. 5. Is an enlarged view of an edge portion of the tool as seen in FIG. 4.

FIG. 6. Is an enlarged cross section of illustration of how the tool would be used.

FIG. 7. Is an illustration of how the tool would be used.

### DETAILED DESCRIPTION OF THE PREFERRED EMBODIMENTS

The mobile phone display membrane separating tool may be made of a flexible metal alloy that is cut to shape especially for the removal of the outer glass membrane. However, the mobile phone display membrane separating tool may be made of any material adaptable for transmitting sufficient force for the tool to operate according to the modes described herein. For example, the mobile phone display membrane separating tool may be made of other metals, plastic, composites or any combination of materials.

Specifically, various embodiments include a metal alloy that is less than 0.15 mm in thickness so that it can easily be pushed in between the separate layers that that comprise the digital visual display. As shown FIG. 6, most digital visual displays of modern touchscreen devices contain 3 layers of glass. (10) being the electronic display, commonly LCD/LED, (11) being the touch sensing unit, also called the digitizer, and (12) being the outer glass membrane. The adhesive (9) layer holds the components together. The outermost adhesive layer is what would be penetrated by the abovementioned tool to separate the outer glass membrane from the rest of the display.

Various embodiments may be larger than the display to allow the tool to be able to separate the membrane as a whole in one piece, while being small enough to allow ease of use.

The following tool has smooth edges to allow for a smoother slicing motion through the adhesive layer (9) while better avoiding damage to the digitizer membrane below as the smooth surface of the bottom side glides gently overtop it. The tip at the end of the taper may be rounded to avoid accidental puncturing of the digitizer and/or the display unit underneath.

The following tool can be used in conjunction with a conventional razor blade or a tool alike (14) to lift the display above the ridge of the surrounding metal frame (16). Once the display has been lifted past the edges of the surrounding metal frame, the tool can be inserted just beneath the glass layer to initiate the separation between the outer glass layer and the rest of the display. The tool is maneuvered side to side along while being inserted until the tool has sliced all of the adhesive holding the piece of glass. A source of heat (15) is also used to apply heat throughout the process to soften the adhesive, thereby easing the process. Isopropyl alcohol or other solvents can be applied on the tool periodically to help reduce the resistance created by the adhesive while also further softening the adhesive.

Various modifications may be made, and various embodiments of the abovementioned tool can be made:

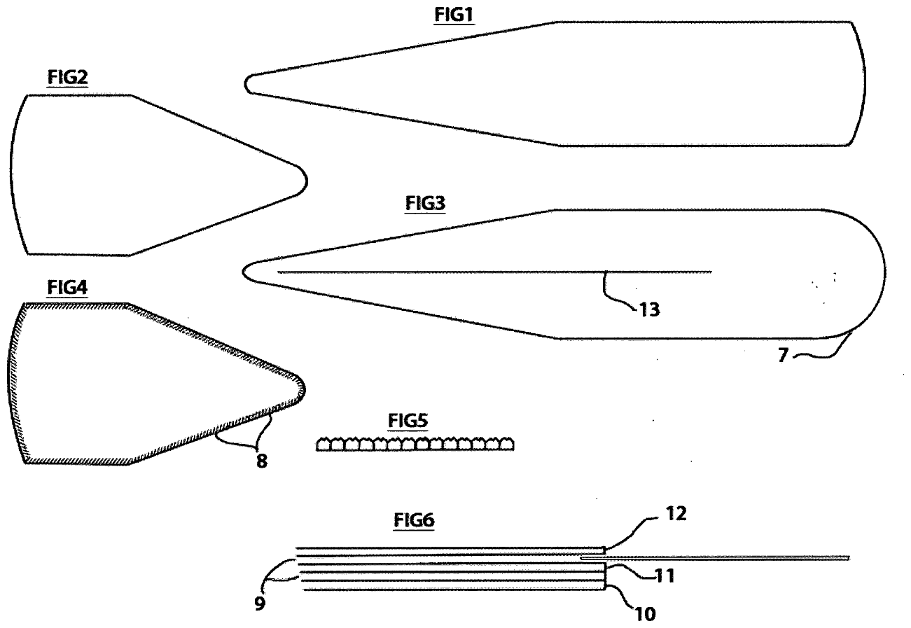

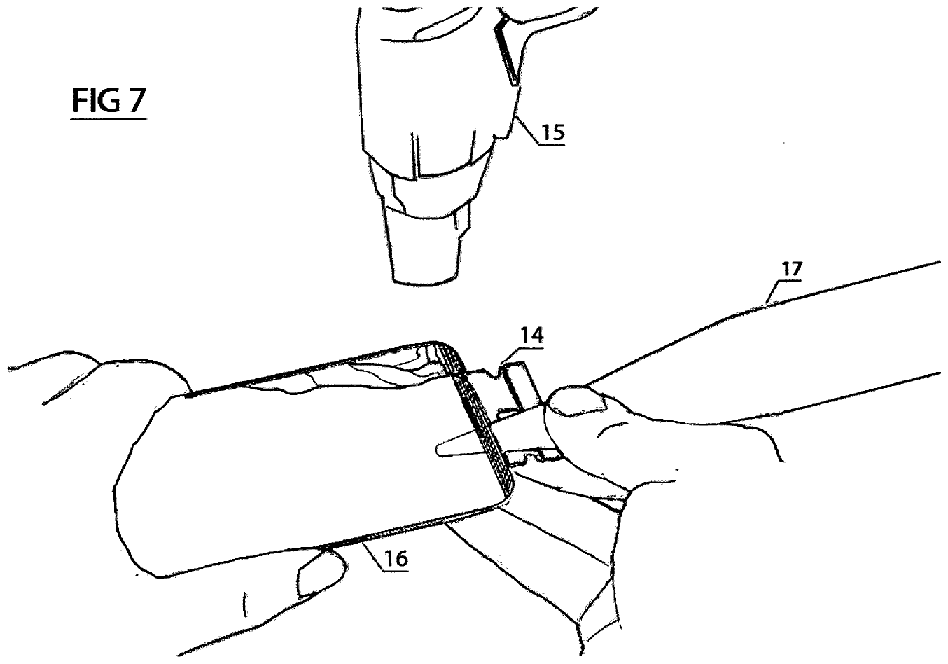

For example, a smaller tool as shown in FIG. 2 for smaller devices or removal of smaller pieces of the mobile phone display membrane. By creating a slit (13) wide enough to apply liquid or solvent for adhesive removal or weakening, it allows for a more efficient membrane separation process. The slit (13) will be narrow enough so that the surface tension of the said liquid or solvent allows for the liquid or solvent to travel along the slit without falling through.

Various modifications may also include rounding the end (7) of the tool for comfortable handling by the user.

Various modifications may also include serrating the edge (8) as shown in FIG. 5 for slicing through a more stubborn adhesive

1. A tool for separating mobile phone display membranes, having a body comprised of flexible metal alloy that is less than 0.15 mm in thickness wherein the flexibility of the material allows the abovementioned tool to bend around curves of curved mobile phone displays and independently return to its original state.

2. The method of separating mobile phone display membranes by positioning a razor blade or utility blade knife or a tool alike to lift and expose the membranes to allow the tool to make the penetration in to the adhesive membrane.

3. The method of separating mobile phone display membranes according to claim 2, wherein using heat to soften the adhesive and inserting the tool of claim 1 between the membranes or layers of the mobile phone display and press the tool in to separate the glass membrane from the rest of the display assembly.
